(19) United States
(12) Patent Application Publication
(10) Pub. No.: US 2021/0217301 A1
(43) Pub. Date: Jul. 15, 2021

(54) COPPER and/or FIBER OPTIC BASED USB CABLE ADDED WITH INTEGRATED IR INFRARED REMOTE CONTROL WITHOUT REDUCING USB CONNECTIONS & STANDARD SPECS

(71) Applicants: Luca ZANETTI, Orlando, FL (US); Silvia FIORAVANTI, Orlando, FL (US)

(72) Inventors: Luca ZANETTI, Orlando, FL (US); Silvia FIORAVANTI, Orlando, FL (US)

(21) Appl. No.: 16/743,536

(22) Filed: Jan. 15, 2020

(51) Int. Cl. G08C 23/04; G02B 6/42; H01B 1/02; H01B 11/22

(52) U.S. Cl. CPC G08C 23/04; H01B 11/22; H01B 1/02; G02B 6/4246

(57) ABSTRACT

A copper and/or fiber optic based USB cable with optical or USB male or female connectors, also added with integrated infrared remote control capabilities configured to remote control uni-directional and bi-directional audio video and ir devices remotely from each-other sides of the usb cable, integrated within same the usb cable, without requiring additional cables and devices, without disrupting or reducing the USB standard & connections full specs. Infrared transmitter and receiver eyes from the USB copper and/or fiber optic based cable can be either or both integrated in the/on to the USB connectors housing shell, keystone, wallplate, multimedia strip, and any other fixed or flying shape of housing, or externally connected via additional ir eyes connectors added on the USB connector housing shell, or extrapolated from the USB copper and/or fiber optic based cable using any flying wiring and any connection solution or direct without connectors.

### BACKGROUND

This invention relates to adding the infrared remote control mechanism to the USB copper and/or fiber-based cables technology and production also called in some cases AOC active optical cables, to be able to remote control in an integrated within-the-same-cable way any USB, av audio video, automation, and any ir remote controllable devices from each-other sides of the cable, without reducing the USB full standard specs connections and functionalities.

### SUMMARY OF THE INVENTION

The present invention is directed to integrating an infrared remote control mechanism within the same USB copper and/or fiber-based cables technology also in some cases called USB AOC active optical cable, in order to facilitate the remote control of IR devices such as remotely installed gaming consoles with av home-theaters receivers, media centers, computers, digital signage devices, security systems, any usb device integrating or combined with ir controlled features and devices, tvs, media players, set top boxes, disk players, av receivers, Bluetooth devices, home automation devices and systems, and any other ir remote controllable device, from each-other sides of cable within the same cable, without requiring additional external cables or devices and installation, without reducing the USB full standard connections and functionalities specs.

### BRIEF DESCRIPTION OF THE DRAWINGS

FIG. 1 schematically illustrates the operation of the infrared mechanism added to the copper and/or AOC USB fiber optic based cables.

FIG. 2 schematically illustrates an example of IR eyes connection connectors installed on the USB copper and/or fiber-based cable housing shell.

FIG. 3 schematically illustrates an example of IR eyes connection connectors flying/floating from the USB copper and/or fiber-based cable housing shell.

FIG. 4 schematically illustrates an example of IR eyes connection connectors flying/floating from the USB copper and/or fiber-based cable.

FIG. 5 schematically illustrates an example of IR eyes connection connectors flying/floating from the USB copper and/or fiber-based cable.

### DETAILED DESCRIPTION

An object of the present invention is to simplify the audio, video, multimedia, automation and any USB device installation by integrating the IR remote control mechanism within the same USB copper and/or Fiber-based cable eliminating the need of additional external converters with their eventual power supply and additional wires and reducing the system installation time and electrical power consumption, increasing the overall reliability and the environmental health.

Another object of the present invention is to be able to use the benefits of the USB fiber-based aoc cables technology which offers zero-lag latency, zero-loss full speed bandwidth, and add to it the ability to control infrared remote devices such as av receivers, media centers, media players, matrixes, switchers, ip players, home automation, set top boxes, and any ir controllable device, typically wanted/installed in another room, closet, basement, in order to keep the installation simple and clean with only the television sets in the rooms, and all the other ir remote controllable components such as gaming consoles, gaming computers, av surround amplifiers, ceiling amplifiers, and other devices away from the room where the TV is installed, without disrupting nor reducing the full USB standard connection & specs features, without introducing lag delays non acceptable when gaming, ir remote control otherwise impossible to do with the regular USB copper and/or fiber-based cables so usually only achievable by adding more external components to the USB cable and/or additional/special shared or dedicated cables and extenders of any type.

To achieve these goals an IR infrared electric block is added and integrated to each of USB copper and/or fiber-based cable sides

The infrared blocks can receive and transmit each-other the infrared commands captured and emitted in the rooms via ir eyes transmitters and receivers sensors connected to the infrared blocks or directly to the cable.

the ir eyes can receive or transmit or receive and transmit ir commands from ir remote controls such as tv remote controls, home automation controls, control tablets and phones, programmable ir remote controls and any ir controller—to audio video tv systems and any ir controllable devices.

the ir eyes can be integrated directly on the usb copper and/or fiber-based cable connectors housing shells and/or ir infrared blocks housing shells of the fiber-based USB cable.

the ir eyes can also be separated parts with a wire connected to the main USB copper and/or fiber-based cable via pluggable connectors such as 3.5 mm jacks or any other, where these pluggable IR ports can be installed and integrated directly inside the USB coper and/or fiber-based cable connector housing shell, or flying floating connectors from the cable.

The ir eyes might also be already connected/wired to each side of the main USB copper and/or fiber-based cable.

The typical installation of the IR-eye receiver is via adhesive in front of the viewing TV, so the IR eye can “see and capture” ir commands coming from the room remote control/s and send them to the other side of the USB copper and/or fiber-optic-based AOC cable reproducing them through the IR-eye transmitter/s in front of the remote controllable destination device/s, controlling it.

Some TV sets also provide a plug-in jack on the rear TV connections, to use the TV IR EYE built-in into the TV in place of installing another adhesive ir eye in front of the TV, usually on the TV bezel. In this case the TV IR EYE jack can be connected directly to the IR INFRARED BLOCK so the ir commands will be captured and delivered to the other side of the USB copper and/or fiber-based cable directly from the IR EYE built-into the TV.

The copper and/or fiber optic infrared with USB cable, connectors and mechanism here described can also be added with additional data connections and connectors such as ethernet, serial, audio, video, data, toslink, spdif, sdi video, multiple sdi video up to 8 k and higher, aes ebu, hdmi, composite video, component video, and any other audio video data connection, to create an infrared cable and mechanism with multiple multi-standard connections and combination, so the infrared mechanism will be able no only to remote control remote USB devices from each-other sides of the IR USB copper and/or optical cable, but as well other different non USB devices, while the IR integrated multi-standard cable will offer multiple types of connection at once with the IR control feature.

By replacing the IR sensors with different source and destination devices, the invention allows the connection between any serial data communication devices within the same USB cable, without disrupting, using or reducing the USB connection full standard and functionality (any type), without requiring additional external adapters converters, repeaters or external additional cables.

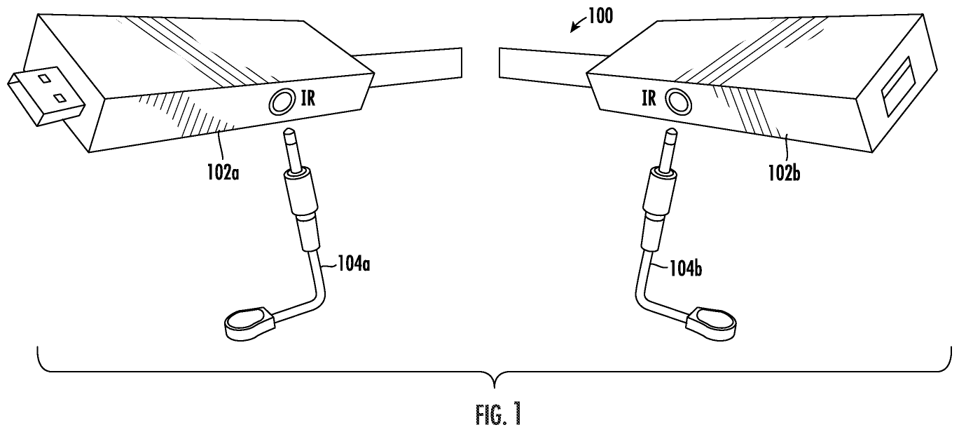

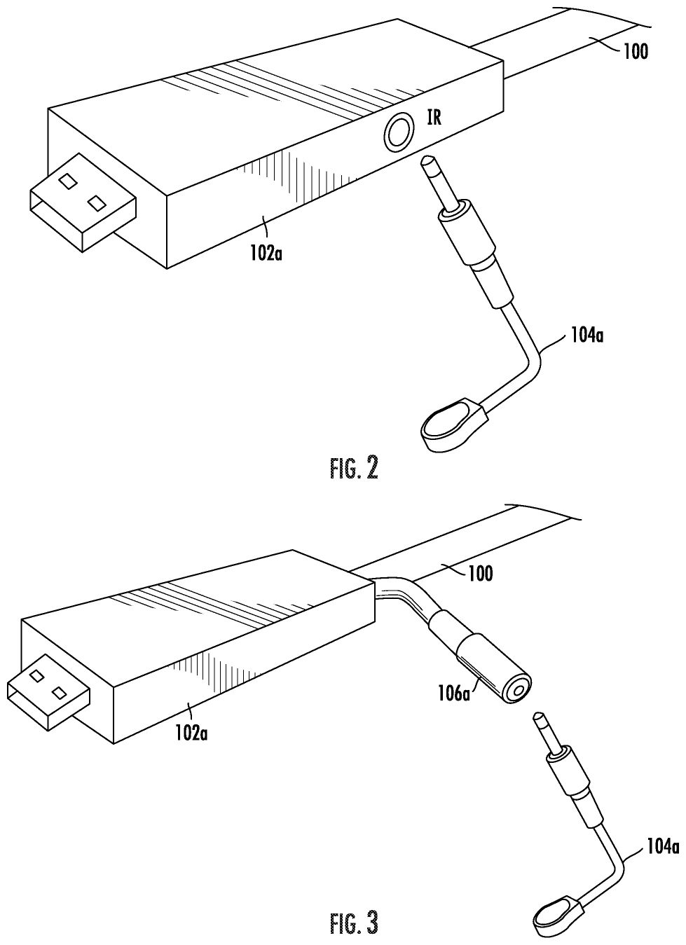

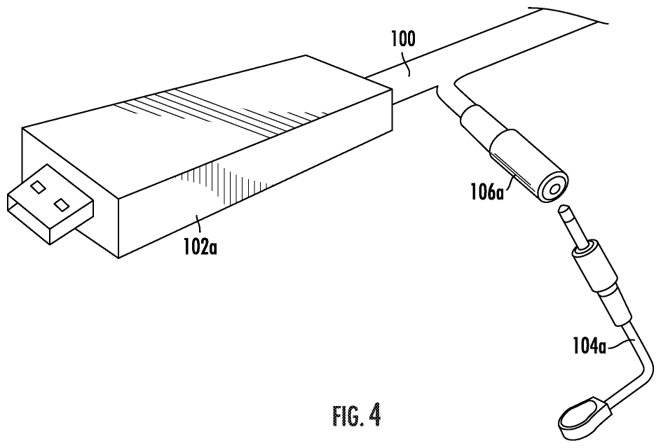

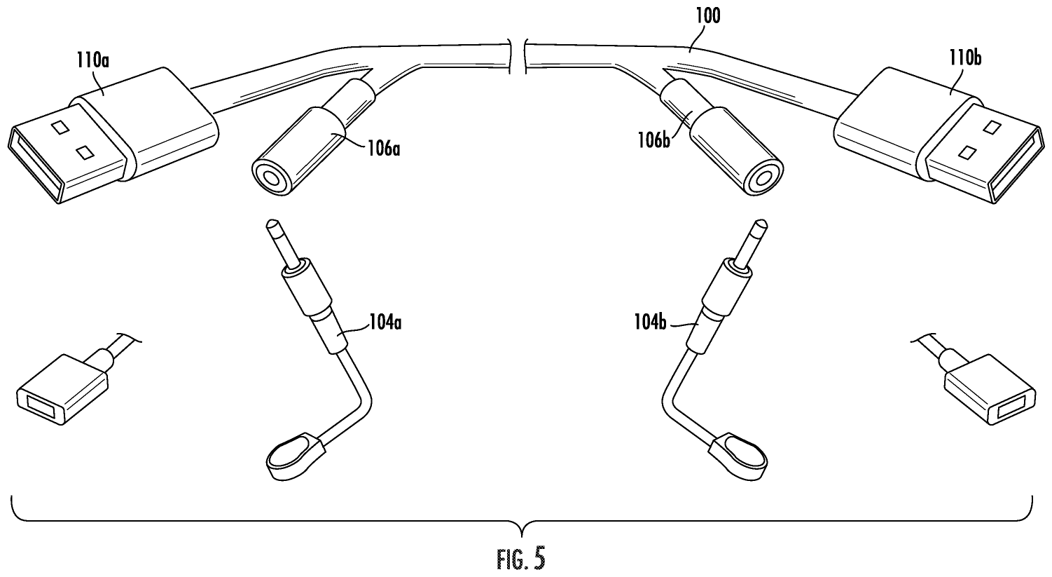

Referring now to FIGS. 1-5, a cable 100 having USB with IR is illustrated. The cable 100 may comprise USB copper and/or fiber based cable with integrated IR remote control extender without limiting USB specs. A USB connector 102a, 102b may be any type, e.g., male-female USB-A, B, C, etc. or any type of connector. IR eyes 104a, 104b may be on the USB connectors or flying directly out of the cable or the connectors. For bi-directional IR common operation, two IR eyes or one TX/RX Eye are required with proper multi-pin connectors. IR circuits may be integrated in the USB connector housing shell or in the IR eyes or in a cable junction block, for example.

1. (canceled)

2. (canceled)

3. (canceled)

4. A universal serial bus (USB) cable comprising:
a first end having an infrared receiver configured for receiving a first set of infrared commands intended for a first device;
a second end opposite the first end and having an infrared transmitter configured to reproduce the first set of infrared commands to control a second device; and
a plurality of copper wires coupled to the infrared receiver at the first end and extending to the infrared transmitter at the second end, and the plurality of copper wires configured to communicate the first set of infrared commands from the infrared receiver to the infrared transmitter at the second end;
wherein at least two of the plurality of copper wires provides for integrated infrared serial remote communications capabilities to control devices remotely from an opposing end of the cable.

5. The USB cable of claim 4, further comprising a plurality of fiber optics extending from the first end to the second end.

6. The USB cable of claim 4, further comprising a first USB connector coupled to the first end, and a second USB connector coupled to the second end.

7. The USB cable of claim 4, further comprising a first IR electric block coupled to the first end and a second IR electric block coupled to the second end.

8. The USB cable of claim 4, wherein the infrared receiver comprises an infrared eye.

9. The USB cable of claim 4, wherein the second end further comprises an infrared receiver configured to receive a second set infrared commands intended for the second device.

10. The USB cable of claim 9, wherein the first end further comprises an infrared transmitter configured to reproduce the second set of infrared commands to control the first device.

11. The USB cable of claim 10, wherein the cable is configured to communicate the second set of infrared commands from the second end to the first end.

12. A universal serial bus (USB) cable, the cable comprising:
a first end having a first infrared receiver and transmitter, wherein the first infrared receiver and transmitter is configured for receiving and reproducing infrared commands;
a second end opposite the first end and having a second infrared receiver and transmitter, wherein the second infrared receiver and transmitter is configured for receiving and reproducing infrared commands; and
a plurality of copper wires coupled between the first infrared receiver and transmitter and the second infrared receiver and transmitter, wherein the plurality of copper wires are configured to communicate infrared commands from a respective infrared receiver to a respective infrared transmitter at an opposing end.

13. The USB cable of claim 12, further comprising a plurality of fiber optics extending from the first end to the second end.

14. The cable of claim 12, further comprising a first USB connector coupled to the first end, and a second USB connector coupled to the second end.

15. The USB cable of claim 13, wherein at least two of the plurality of copper wires provides for integrated infrared serial remote communications capabilities to control devices remotely from an opposing end of the USB cable.

16. The USB cable of claim 12, further comprising a first IR electric block coupled to the first end and a second IR electric block coupled to the second end.

17. The USB cable of claim 14, wherein the infrared receiver comprises an infrared eye.

18. The USB cable of claim 12, further comprising coupling the first infrared transmitter directly into the second device.

19. The USB cable of claim 12, further comprising an infrared eye coupled to each of the first infrared receiver and transmitter and the second infrared receiver and transmitter.

20. A universal serial bus (USB) cable, the cable comprising:
a first end having a first infrared eye configured for receiving and reproducing infrared commands;
a second end opposite the first end and having a second infrared eye configured for receiving and reproducing infrared commands; and
a plurality of electric wires coupled between the first infrared eye and the second infrared eye, wherein the plurality of electric wires are configured to communicate infrared commands in either direction between the first infrared eye and the second infrared eye.

21. The cable of claim 20, further comprising a plurality of fiber optics extending from the first end to the second end.

22. The USB cable of claim 20, further comprising a first IR electric block coupled to the first end and a second IR electric block coupled to the second end.

23. The USB cable of claim 20, further comprising an outer covering to provide for a unitary cable from the first end to the second end.
